(19) United States
(12) Patent Application Publication
(10) Pub. No.: US 2015/0144205 A1
(43) Pub. Date: May 28, 2015

(54) INFLATION AND EXCESS PRESSURE RELEASE DEVICE FOR A WHEEL WITH PNEUMATIC TIRE

(71) Applicant: Schrader, Pontarlier (FR)

(72) Inventors: Maxime Pourchet, Pontarlier (FR); Pierre-Antoine Guenot, Saint Gorgon Main (FR)

(21) Appl. No.: 14/552,629

(22) Filed: Nov. 25, 2014

(30) Foreign Application Priority Data
Nov. 28, 2013 (FR) 1361756

(51) Int. Cl. B60C 29/06; F16K 15/20

(52) U.S. Cl. CPC B60C 29/068; F16K 15/207
USPC 137/225

(57) ABSTRACT

An inflation device for a wheel with a pneumatic tire. A valve having a seat carried by a body and a head separates a chamber from an output connector. The head is movable within the chamber between a closed position wherein it is in abutment on the seat and an open position wherein it is separated from the seat so as to put the radial openings into communication with the output connector. The head is elastically held in the closed position against the seat so as to allow lifting of the head when the pressure in the output connector is greater than a predetermined threshold.

### RELATED APPLICATION

The present application claims priority to French Application No. 1361756 filed Nov. 28, 2013, which is incorporated herein in its entirety by reference.

### TECHNICAL FIELD

The invention relates to an inflation device for a wheel with a pneumatic tire.

### PRIOR ART

In the case of large-diameter wheels, with large-volume pneumatic tires such as for example those that equip loaders used on open-pit mining sites, an inflation device providing a high flow rate is used. Such a device comprises for example a body intended to be fastened to the wheel by an output connector discharging into the tire. The body comprises radial openings discharging into a chamber contained within the body and on an outer surface of the body, the chamber being separated from the output connector by a valve consisting of a seat borne by the body and a head. The head is carried by operating means so as to be movable within the chamber between a closed position wherein it is in abutment against the seat and an open position wherein it is separated from the seat so as to put the openings into communication with the output connector. Inflation is obtained by means of a connecting ring connecting air-tight around the body at the radial openings. The stem is operated manually to put the connector into communication with the interior of the pneumatic tire.

Pneumatic tires are subjected to large forces, such that they can heat up and the pressure of the air that they contain can increase to the point of posing a risk of bursting the tire. To avoid this risk, the rim of the wheels comprises a safety device which opens when the pressure is too high. This device is based on a thin diaphragm which ruptures under pressure. The tire then deflates completely. While the tire is protected by this operation, the same is not true of the vehicle, which as a result is immobilized and can find itself in an awkward, or even perilous, position.

The invention aims to provide a device allowing high-flow-rate inflation of a tire while still providing a high degree of safety for the tire and the vehicle equipped with it.

### DESCRIPTION OF THE INVENTION

With these goals in mind, the invention has as its object an inflation device for a wheel with a pneumatic tire comprising a body intended to be fastened to the wheel by an output connector discharging into the tire, the body comprising radial openings discharging into a chamber contained in the body and on an outer surface of the body, the chamber being separated from the output connector by a valve consisting of a seat carried by the body and a head, the head being carried by operating means so as to be movable within the chamber between a closed position wherein it is in abutment against the seat and an open position wherein it is separated from the seat so as to put the openings in communication with the output connector, the device being characterized in that the operating means comprise elastic holding means acting elastically on the head against the seat in the closed position so as to allow the head to lift when the pressure in the output connector is greater than a predetermined threshold.

By elastically holding the head on the seat, it is allowed to separate from the seat under the influence of the pressure prevailing in the pneumatic tire. Some air is then allowed to escape, and therefore to reduce the pressure in the tire. As soon as the pressure has returned to a predetermined level, the head returns to its position on the seat and air-tightness is restored. Sufficient pressure is thus maintained in the tire that the vehicle is neither destabilized nor immobilized. Moreover, bursting of the pneumatic tire is prevented.

According to one particular arrangement, the body comprises on the outside surface two smooth circular seats on either side of the openings to provide a seal with a connecting ring intended to fit over the body. The openings provide a large flow cross-section for the air during inflation. The seats are intended to form a seal with gaskets carried for example by the ring which can thus supply with air all the openings distributed over the periphery of the body. A high air flow is thus possible.

According to one embodiment, the operating means comprise a threaded sleeve cooperating with an inside thread of the body and bearing the elastic holding means, the sleeve comprising an operating member to drive its rotation and to move the head between the closed position and the open position. The sleeve allows manual opening of the valve by screwing and unscrewing it. It carries with it the elastic holding means, such that these perform their function in the closed position.

Particularly, the elastic holding means comprise a stem mounted sliding within the sleeve and bearing the head, elastic elements supported on the sleeve and acting on the stem and tending to press the head against the seat. Guidance is provided for the head in a sliding motion parallel to the manual opening and closing motion.

According to a supplementary arrangement, the elastic holding means comprise stop means limiting the travel of the stem within the sleeve. It is thus possible to obtain a pre-loading of the elastic means such that the head only lifts after a threshold determined by the preload.

According to one embodiment, the stop means comprise a circular groove on the stem, a stop shoulder on the sleeve and at least two portions of the stepped ring lodged inside the circular groove, the shoulder of the ring forming a stop against the stop shoulder. The stop function is thus obtained after having inserted the stem into the sleeve through one end of the sleeve, then having placed the portions of the stepped ring into the circular groove at the other end of the sleeve. The stepped sleeve thus prevents withdrawal of the stem from the body.

According to another arrangement, the stem is hollow and opens into the output connector, and it comprises a valve allowing adjustment of the pressure inside the tire through the stem. Thus an additional function is available, allowing fine adjustment of the pressure in the tire, with a standard connection valve like a valve of the “Schrader” type. The connection with an inflator is made at an end opposite to the head. The air passes through the stem from one end to the other, independently of the position of the head. The valve maintains a closure absent the use of the connection.

According to one improvement, the device also comprises a removable cap covering the body opposite the output connector. Thus, all the components of the device are protected by the cap. The cap is for example screwed into a thread provided on the body, between the openings and the output connector.

According to a supplementary feature, the cap comprises a lid sealing an opening, the lid being detachable under the influence of the pressure prevailing between the lid and the body. Thus, even in the presence of the cap, the air which may escape through the openings due to lifting of the head by excess pressure can also escape through the opening in the cap, freed of the lid. Moreover, the absence of a lid makes it possible to signal that an overpressure has occurred and that some air has escaped. It is then easy to determine that a maintenance operation is necessary.

### BRIEF DESCRIPTION OF THE FIGURES

The invention will be better understood and other particularities and advantages will appear upon reading the description that follows, the description referring to the appended drawings, of which:

FIG. 1 is a partial section view of a wheel comprising a device according to the invention;

FIG. 2 is a view detail II of FIG. 1;

FIG. 3 is a section view of the device, in the condition of FIG. 2;

FIG. 4 is a view similar to FIG. 3, with an annular ring connected to allow inflation and in the open position;

FIG. 5 is a view similar to FIG. 3, in the overpressure condition.

### DETAILED DESCRIPTION

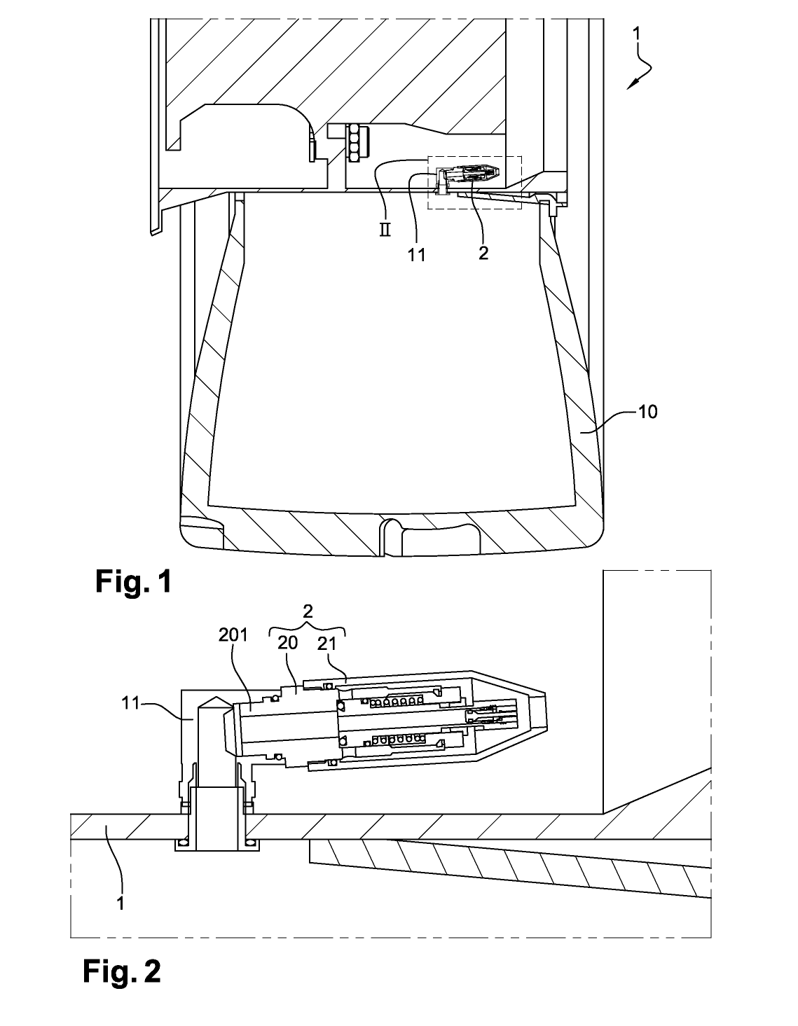

A wheel 1 with a pneumatic tire 10 as shown in FIGS. 1 and 2 is equipped with an inflation device 2 conforming to an embodiment of the invention. The device 2 comprises a body 20 of elongated shape fastened to the wheel 1 by an output connector 201 and through a right-angle elbow 11 discharging into the tire 10. The device 2 comprises a removable cap 21 covering the body 20 opposite to the output connector 201. The cap 21 comprises a thread cooperating with a complementary thread made on an outer surface 202 of the body 20 in proximity to the output connector 201.

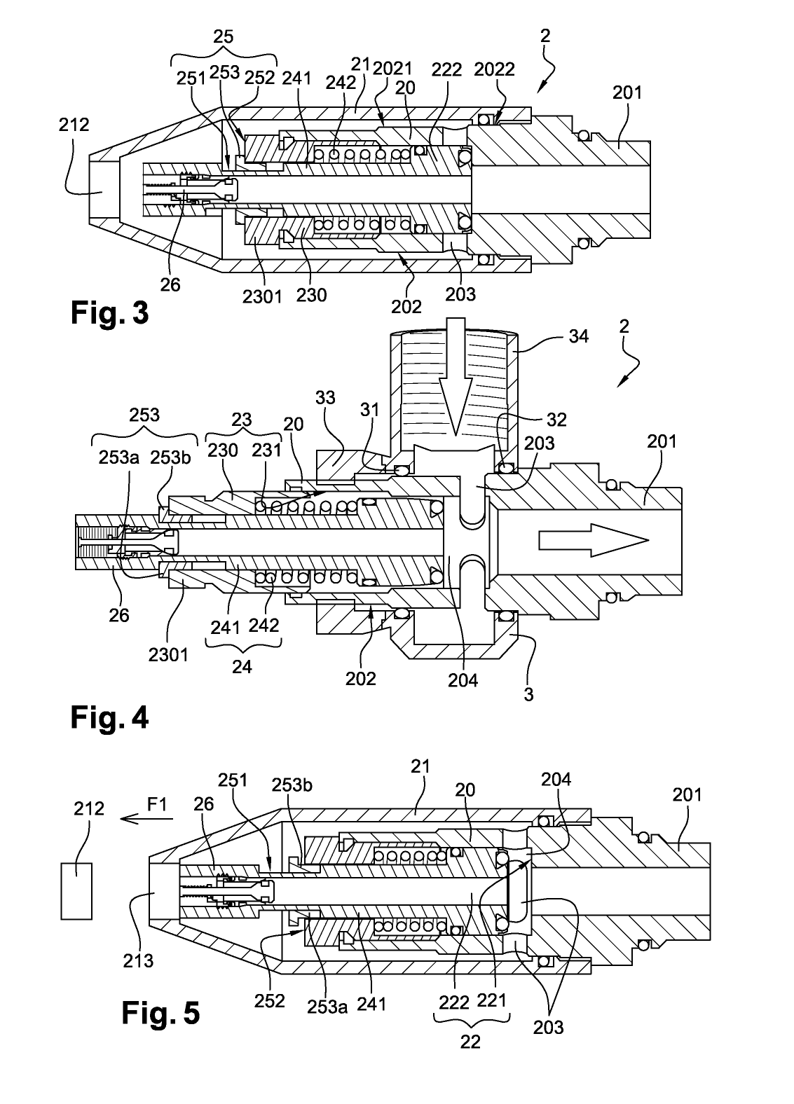

The body 20 comprises radial openings 203 discharging into a chamber 204 contained in the body 20 and on the outer surface 202 of the body 20, inside the cap 21. The chamber 204 is separated from the output connector 201 by a valve 22 constituted by a seat 221 carried body 20 and a head 222. The head 222 is carried by operating means 23 so as to be movable within the chamber 204 between a closed position wherein it is in abutment on the seat 221, as shown in FIG. 3, and an open position wherein it is separated from the seat 221 so as to put the radial openings 203 in communication with the output connector 201, as shown in FIG. 4.

The body 20 comprises, on the outer surface 202, two smooth circular seats 2021, 2022 on either side of the radial openings 203. As shown in FIG. 4, a connecting ring 3, not constituting a part of the device 2, fits air-tight over the body 20 with O-rings 31, 32 abutting the circular seats 2021, 2022. A nut 33 cooperating with a thread on the body 20 makes it possible to fix the connecting ring 3 on the device 2. The connecting ring 3 is intended to supply the device 2 with compressed air through a hose, not shown, which connects to a supply connector 34.

Operating means 23 comprise a threaded sleeve 230 cooperating with an inside thread 231 of the body 20. The operating means 23 comprise elastic holding means 24 which carry the head 222. The sleeve 230 comprises an operating member 2301 to drive its rotation and move the head 222 between the closed position and the open position by the screwing and unscrewing effect. The operating member 2301 is for example a hexagonal shape.

The elastic holding means 24 act elastically upon the head 222 in the closed position, opposing the seat 221 so as to allow the head 222 to lift when the pressure in the output connector 201 is greater than a predetermined threshold. To this end, the elastic holding means 24 comprise a stem 241 mounted sliding within the sleeve 230 and bearing the head 222, elastic elements in the form of a coil spring 242 supported on the sleeve 230 and acting on the stem 241, tending to push the head 222 against the seat 221. The elastic holding means 24 also comprise stop means 25 limiting the travel of the stem 241 in the sleeve 230. The stop means 25 comprise, on the one hand, a circular groove 251 on the stem 241, a stop shoulder 252 on the sleeve 230 and two portions 253a, 253b of stepped ring 253 accommodated in the circular groove 251. The shoulder of the stepped ring 253 forms a stop against the stop shoulder 252. On the other hand, the head 222 forms a stop for the sliding of the stem 241 in the opening direction, shown by the arrow F1 after compression of the coil spring 242.

Moreover, the stem 241 is hollow, opening toward the output connector 201. At its end opposite to the output connector 201, it comprises a valve 26 allowing connection of an inflator and adjustment of the pressure in the pneumatic tire 10 through the stem 241.

The cap 21 also comprises a lid 212 sealing a cap opening 213, the lid 212 being detachable under the influence of the pressure prevailing between the cap 21 and the body 20.

When the device 2 is in place on a wheel 1 with a tire 10, the cap 21 is in place, as shown in FIG. 2. The device 2 is in the closed position, the head 222 being pressed by the spring 242 into abutment on the seat 221. The seal is achieved there and the air contained in the tire 10 cannot escape.

To rapidly inflate the tire 10, the cap 21 is withdrawn by unscrewing it, the connecting ring 3 is fitted over the body 20 and the nut 31 is screwed on so as to hold it there. The ring is then supplied with compressed air. The operating means 23 are then actuated by unscrewing the sleeve 230 so as to bring the head 222 into the open position, as shown in FIG. 4. The air can then pass from the connecting ring 3 to the chamber 204 through the radial openings 203, then to the output connector 201 and the inside of the pneumatic tire 10. The operating means 23 are actuated by screwing in the sleeve 230 so as to bring the head 222 into the closed position when the fill is sufficient. The connecting ring 3 can then be withdrawn and the cap 21 put back in place.

If it is desirable to carry out a pressure adjustment, a conventional inflator can be used to connect to the valve 26 after having removed the cap 21, the air passing from the inflator through the stem 241 to the output connector 201 and the inside of the tire 10, or in the opposite direction.

If an overpressure occurs in the pneumatic tire 10, this acts on the head 222 opposite to the spring 242. Starting at a pressure predetermined by calibration of the spring 242, between 8 and 10 bar for example, the head 222 moves toward the open position and allows air to pass into the chamber 204, then through the radial openings 203. The pressure then allows the lid 212 to be ejected so that the air escapes through the cap opening 213. As soon as the pressure has returned to a level below the predetermined pressure, the head 222 returns to its place on the seat 221 in the closed position and re-closes the device 2. The pressure in the tire 10 is thus maintained at a level guaranteeing the safety and continuity of operation of the tire 10.

1. An inflation device for a wheel with a pneumatic tire, the device comprising a body intended to be fastened to the wheel by an output connector discharging into the tire, the body comprising radial openings discharging into a chamber contained in the body and to an outer surface of the body, the chamber being separated from the output connector by a valve comprising a seat carried by the body and a head, the head being carried by operating means so as to be movable inside the chamber between a closed position wherein it is in abutment on the seat and an open position wherein it is separated from the seat so as to put into communication the radial openings and the output connector, wherein the operating means comprise elastic holding means acting elastically on the head in the closed position opposite to the seat so as to allow lifting of the head when the pressure in the output connector is greater than a predetermined threshold.

2. The device according to claim 1, wherein the body comprises, on the outer surface, two smooth circular seats on either side of the radial openings to form a seal with a connecting ring intended to fit over the body.

3. The device according to claim 1, wherein the operating means comprise a threaded sleeve cooperating with an inside thread of the body and bearing elastic holding means, the sleeve having an operating member to drive its rotation and move the head between the closed position and the open position.

4. The device according to claim 3, wherein the elastic holding means comprise a stem mounted sliding inside the sleeve and bearing the head, the elastic elements being supported on the sleeve and acting on the stem, tending to press the head against the seat.

5. The device according to claim 4, wherein the elastic holding means comprise stop means limiting the travel of the stem inside the sleeve.

6. The device according to claim 5, wherein the stop means comprise a circular groove on the stem, a stop shoulder on the sleeve and at least two portions of stepped ring accommodated in the circular groove, the shoulder of the ring forming a stop with the stop shoulder.

7. The device according to claim 4, wherein the stem is hollow and opening into the output connector, and comprises a valve allowing adjustment of the pressure in the tire through the stem.

8. The device according to claim 1, including a removable cap covering the body opposite to the output connector.

9. The device according to claim 8, wherein the cap comprises a lid sealing a cap opening, the lid being detachable under the influence of the pressure prevailing between the cap and the body.
